(19) United States
(12) Patent Application Publication
(10) Pub. No.: US 2004/0192567 A1
(43) Pub. Date: Sep. 30, 2004

(54) Cleaning agent and cleaning method using the cleaning agent

(75) Inventor: Kenji Yamashita, Hyogo (JP)

Correspondence Address: LEYDIG VOIT & MAYER, LTD, 700 THIRTEENTH ST. NW, SUITE 300, WASHINGTON, DC, 20005-3960, US

(73) Assignee: Yamashita Works Co., Ltd., Amagasaki (JP)

(21) Appl. No.: 10/807,172

(22) Filed: Mar. 24, 2004

(30) Foreign Application Priority Data
Mar. 31, 2003 (JP) 2003-095227

(51) Int. Cl. C11D 1/00

(52) U.S. Cl. 510/267

(57) ABSTRACT

A stream of particles of a cleaning agent is ejected against an object to be cleaned so that the particles collide with a surface of the object. The cleaning agent includes particulate bodies made of gelatin or animal glue, and containing water to impart viscosity and elasticity, and stick-free fragments held on an outer surface of each particulate body. The particulate bodies maintain their viscosity and elasticity by retaining the water so that the cleaning agent can capture and remove foreign material adhering to the surface of the object.

### BACKGROUND OF THE INVENTION

1. Field of the Invention

The present invention relates to a cleaning agent having outstanding cleaning performance and a cleaning method using the cleaning agent of the invention.

2. Description of the Background Art

There exist various kinds of conventionally known cleaning agents used for cleaning surfaces of an object to be cleaned (e,.g., a device or a component thereof) by shooting, or blasting, particles of the cleaning agent against the surfaces. One example of the conventional cleaning agents is disclosed in Japanese Laid-open Patent Publication No. 2002-36252. According to the Publication, particles of a shooting material (cleaning agent) are blasted against an object to be cleaned at high speeds so that foreign materials adhering to or left on surfaces of the object are removed with the aid of a “hammer effect” produced by repetitive impacts caused by the shooting material.

The conventional cleaning agent is blasted in small particles to clean the surfaces of the object to be cleaned by the hammer effect as mentioned above. The cleaning agent using this hammer effect approach has a problem that it is difficult to remove tenacious deposits of foreign materials persistently holding on the surfaces of the object to be cleaned if the foreign materials are such substances that magnetically stick to metallic surfaces or electrostatically adhere to the object to be cleaned with great force.

### SUMMARY OF THE INVENTION

Intended to overcome the aforementioned problem of the conventional cleaning agents, the invention has as an object the provision of a cleaning agent which can clean an object to be cleaned in a reliable fashion as well as a cleaning method using the cleaning agent.

According to a principal feature of the invention, a cleaning agent for cleaning a surface of an object to be cleaned by producing collision between the cleaning agent and the object includes a plurality of particulate bodies, water contained in the particulate bodies, and a plurality of stick-free fragments held on an outer surface of each of the particulate bodies. The particulate bodies are made essentially of a material selected from the group consisting of gelatin and animal glue. The water contained in the individual particulate bodies imparts viscosity and elasticity thereto. The stick-free fragments serve to prevent the individual particulate bodies from sticking to one another due to the viscosity thereof and to maintain the particulate bodies in an original shape thereof. The cleaning agent is used under conditions where the particulate bodies maintain the viscosity and the elasticity by retaining the water therein so that the cleaning agent can capture a foreign material on the surface of the object with the aid of the viscosity of the particulate bodies.

The cleaning agent thus structured can entrap and remove foreign materials firmly adhering to or left on surfaces of the object to be cleaned with great force, such as a magnetic force, with the aid of elastic and viscous properties of the individual particulate bodies in a reliable fashion.

These and other objects, features and advantages of the invention will become more apparent from a reading of the following detailed description associated with the accompanying drawings.

### BRIEF DESCRIPTION OF THE DRAWINGS

FIGS. 1A and 1B are diagrams showing the structure of a single particle of a cleaning agent according to a first embodiment of the invention;

FIG. 2 is a diagram showing the construction of a blasting device designed to use the cleaning agent of the first embodiment in performing cleaning operation;

FIGS. 3A to 3C are diagrams showing a cleaning process performed by using a conventional cleaning agent;

FIGS. 4A to 4C are diagrams showing a cleaning process performed by using the cleaning agent of the invention; and

FIGS. 5A and 5B are diagrams showing the structure of a single particle of a cleaning agent according to a second embodiment of the invention.

### DETAILED DESCRIPTION OF THE PREFERRED EMBODIMENTS OF THE INVENTION

The invention is now described, by way of example, with reference to specific embodiments thereof.

### First Embodiment

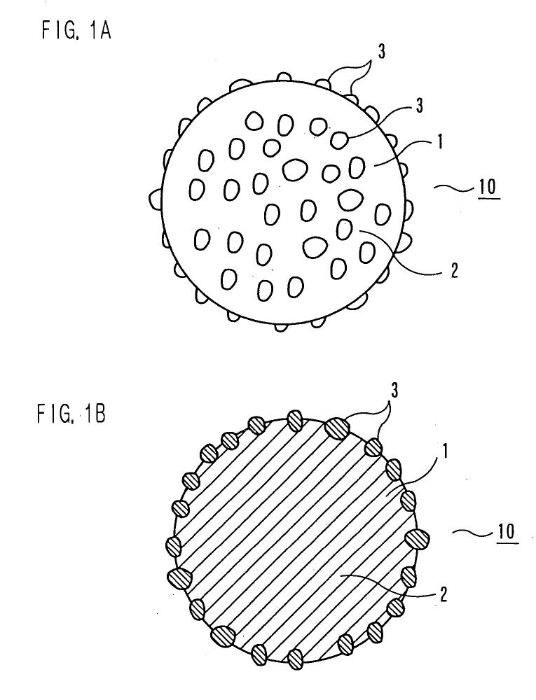

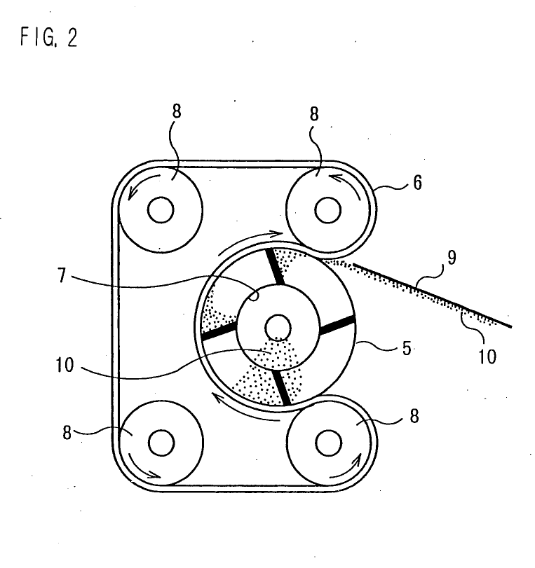

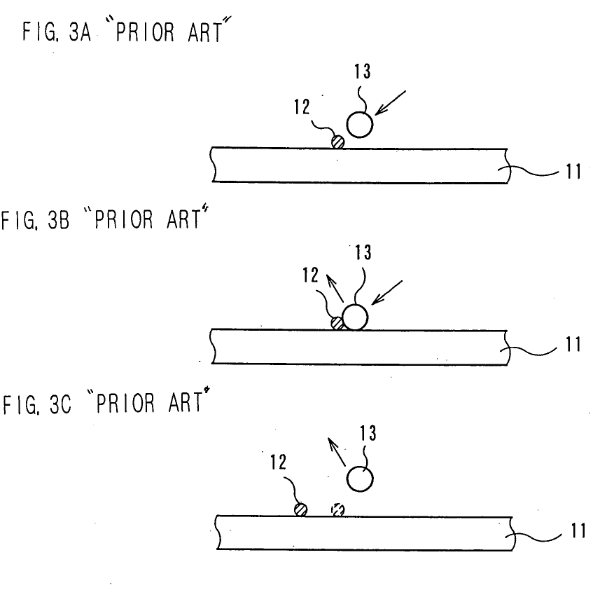

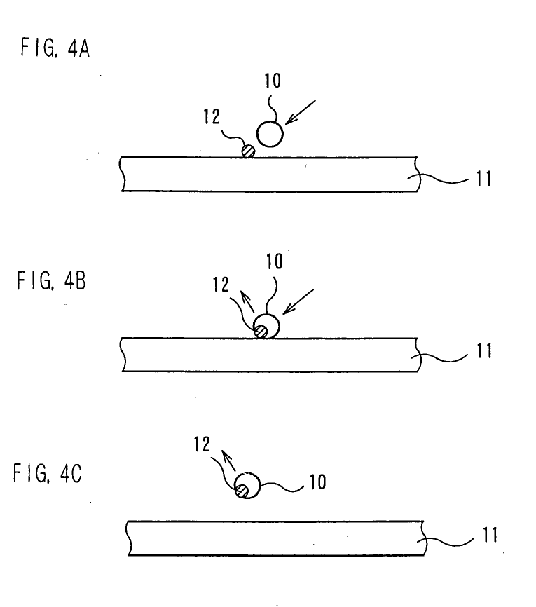

FIG. 1A is a diagram showing the structure of a single particle of a cleaning agent 10 according to a first embodiment of the invention, FIG. 1B is a sectional view of the particle of the cleaning agent 10 of FIG. 1A, FIG. 2 is a diagram showing the construction of a blasting device designed to use the cleaning agent 10 of FIGS. 1A and 1B in performing cleaning operation, FIGS. 3A to 3C are diagrams showing a cleaning process performed by using a conventional cleaning agent 13, and FIGS. 4A to 4C are diagrams showing a cleaning process performed by using the cleaning agent 10 of the invention.

Referring to FIGS. 1A and 1B, the particle of the cleaning agent 10 includes a particulate body 1, which exhibits elastic and viscous properties when containing water 2 as illustrated, and a plurality of stick-free fragments 3 held on the surface of the particulate body 1 due to the viscous nature thereof.

More particularly, the particulate body 1 includes as its main constituent gelatin or animal glue which gains elasticity and viscosity by absorbing water. Having a generally spherical shape, the particulate body 1 made of gelatin or animal glue measures 0.1 mm to 3 mm in diameter. The stick-free fragments 3 are small pieces of ceramic material which may be, for example, diamond, silicon carbide, alumina, glass, zirconia or a combination of substances selected therefrom. The stick-free fragments 3 serve to prevent the individual particulate bodies 1 from sticking to one another due to the viscosity thereof and to maintain the particulate bodies 1 in their original shape.

Substances other than ceramic materials, such as plant-derived substances like wheat flour or walnut shells and animal-derived substances, if used as stick-free fragments will be mixed into cleaning agent particles and become “buried” therein due to the nature of the substances depending on conditions of use or cleaning time, for instance. It will be understood from the foregoing that these non-ceramic materials can not perform a function required for the stick-free fragments 3, and that the aforementioned types of ceramic materials usable in a wide range of conditions are best suited as the stick-free fragments 3. In addition, considering the fact that particles of the cleaning agent 10 of the invention are shot against an object to be cleaned to clean its surfaces, it will be appreciated that diamond having high impact resistance is particularly suited for use as the stick-free fragments 3 from the viewpoint of the durability of the cleaning agent 10. Taking into account the size of the particulate body 1 and the required function of the stick-free fragments 3, the stick-free fragments 3 should preferably have a diameter of 1 μm to 20 μm.

As an example, a desirable composition for producing the cleaning agent 10 of the invention is obtained by adding 200 g to 700 g of water 2 and a specific amount of stick-free fragments 3 containing 100 carats±10 carats of diamond, 50 g±10 g of silicon carbide and 50 g±10 g of alumina, when these materials are used, to 1000 g of particulate bodies 1.

If the amount of water 2 added in producing the composition mentioned above is insufficient, the elasticity and viscosity of the particulate bodies 1 will be inadequate, and the cleaning agent 10 thus produced would be unable to clean surfaces of an object by entrapping and removing foreign materials sticking thereto, or the cleaning agent 10 can only offer a limited cleaning effect at best. If an excessive amount of water 2 is added in producing the composition, on the hand, the particles of the cleaning agent 10 themselves will remain adhered to the surfaces of the object after the cleaning process so that the object can not be thoroughly cleaned. Under these circumstances, the amount of water 2 to be added should be between 200 g and 700 g.

The aforementioned amount of the stick-free fragments 3 has been determined such that the stick-free fragments 3 would uniformly spread over the surface of each particle of the cleaning agent 10 as illustrated. This amount should be properly adjusted depending on the shape and materials used as the stick-free fragments 3.

A method of producing the cleaning agent 10 of the present embodiment is described hereunder. First, an appropriate amount of water 2 is applied to a mass of dry particulate bodies 1 by spraying, for example, so that the surfaces of the particulate bodies 1 gain viscosity by absorbing the sprayed water 2. Next, stick-free fragments 3 (well mixed when different substances are used) are applied to the particulate bodies 1 so that the stick-free fragments 3 uniformly adhere to the surfaces of the particulate bodies 1 which now have a desired viscosity upon absorbing the applied water 2. As a result, particles of the cleaning agent 10 as shown in FIGS. 1A and 1B are obtained.

Another method of producing the cleaning agent 10 of the embodiment is as follows. First, appropriate amounts of dry particulate bodies 1 and stick-free fragments 3 are mixed to produce a well-blended mixture thereof. Then, while stirring the mixture, an appropriate amount of water 2 is applied by spraying, for example, to the mixture of the particulate bodies 1 and the stick-free fragments 3. When the particulate bodies 1 absorb the applied water 2, the particulate bodies 1 gain viscosity. As a consequence, the stick-free fragments 3 adhere to the surfaces of the particulate bodies 1, whereby particles of the cleaning agent 10 as shown in FIGS. 1A and 1B are obtained.

Referring now to FIG. 2, the blasting device includes an impeller 5 having a plurality of flat vanes which are fixedly sandwiched between two circular disks, the vanes being forwardly inclined with respect to a rotating direction of the impeller 5. The blasting device further includes a belt 6, a cleaning agent inlet 7 formed in the impeller 5, a plurality of pulleys 8 and a blasting nozzle 9. The belt 6 is mounted on the pulleys 8 and around part of an outer circumferential surface of the impeller 5 to transmit rotary motion of the pulleys 8 to the impeller 5. The cleaning agent 10 is fed into the impeller 5 through the cleaning agent inlet 7 and forcefully ejected in a high-speed stream from the impeller 5 through the blasting nozzle 9 against the object to be cleaned.

A cleaning method carried out by using the blasting device thus constructed is now explained below. When an operator turns on the blasting device, the belt 6 mounted on the pulleys 8 runs in a direction shown by arrows in FIG. 2 so that the impeller 5 turns in its rotating direction as illustrated. The cleaning agent 10 is then fed into the impeller 5 through the cleaning agent inlet 7. Forced by a wind pressure and a centrifugal force produced inside the rotating impeller 5, particles of the cleaning agent 10 gradually accumulate in peripheral areas of an internal space of the impeller 5. Since the impeller 5 rotates along the belt 6, the particles of the cleaning agent 10 are ejected in a tangential direction of the impeller 5 from a point where the belt 6 comes apart from the outer circumferential surface of the impeller 5. The blasting nozzle 9 is mounted in such a way that its axis coincides with the aforementioned tangential direction of the impeller 5. Thus, the stream of the cleaning agent 10 is spewed from the impeller 5 through the blasting nozzle 9 toward the object, which is cleaned by the colliding particles of the cleaning agent 10. The particles of the cleaning agent 10 once used for cleaning are collected and fed again into the impeller 5 through the cleaning agent inlet 7 for cyclical use in further cleaning operation.

The inventor carried out experiments in which the cleaning agent 10 was applied to various kinds of objects containing metallic material as a main constituent. Experimental results have demonstrated that the cleaning agent 10 of the embodiment is useful for cleaning surfaces of such materials as high-speed tool steel, die steel, superhard alloy, iron, aluminum and copper.

The cleaning process may be preceded by various kinds of other processes. If the cleaning process is preceded by a polishing process, for instance, debris or odd parts of the polished object, such as burrs, produced during polishing operation may be left on surfaces of the object. If the object to be cleaned is a magnetic material, the object itself gains magnetism as a result of the polishing operation and pieces of foreign matter (e.g., debris or odd parts) could adhere to the object due to a magnetic force exerted the object itself.

Under conditions where such pieces of foreign matter firmly adhere to the object to be cleaned, a great force is needed to remove these pieces from the surface of the object, so that it is impossible to thoroughly clean the object by a conventional cleaning method. As an example, if paint is applied to the surface of the object on which the pieces of foreign matter remain unremoved after the cleaning process, the paint will not properly adhere to the surface, producing such problems as peeling of a coat of the applied paint or an outer coating applied to the painted surface.

Here, the principle of the cleaning process performed by using the conventional cleaning agent 13 is explained with reference to FIGS. 3A to 3C. As shown in FIG. 3A, there is a foreign material 12 sticking to a surface of an object 11 to be cleaned. The cleaning agent 13 is spewed by using a cleaning apparatus which includes the aforementioned blasting device so that a particle of the cleaning agent 13 is shot against the foreign material 12 as illustrated in order to remove the foreign material 12 from the surface of the object 11. Even if the particle of the cleaning agent 13 collides with the foreign material 12 12 as shown in FIG. 3B, however, the foreign material 12 only moves along the surface of the object 11 as shown in FIG. 3C, and can not be removed from the surface. This is because the foreign material 12 is attracted to the object 11 with great force. It is often impossible to properly clean the object 11 by the conventional cleaning process as illustrated. Even if the foreign material 12 moved by the colliding particle of the cleaning agent 13 comes off the surface of the object 11, the foreign material 12 could adhere again to the object 11 or to an inner wall surface of the cleaning apparatus, because the foreign material 12 remains within the cleaning apparatus and hinders successful cleaning operation even after removal from the surface of the object 11.

The principle of the cleaning process performed by using the cleaning agent 10 of the embodiment of the invention is now explained with reference to FIGS. 4A to 4C. Again, there is a foreign material 12 sticking to a surface of an object 11 to be cleaned as shown in FIG. 4A. The cleaning agent 10 is spewed by using the cleaning apparatus including the blasting device so that a particle of the cleaning agent 13 is shot against the foreign material 12 as illustrated to remove the foreign material 12 from the surface of the object 11. As the particle of the cleaning agent 13 collides with the foreign material 12, the cleaning agent 13 entraps the foreign material 12 to the inside of the particulate body 1 due to the elasticity and viscosity thereof as shown in FIG. 4B. As a result of collision between the particle of the cleaning agent 13 and the object 11, the particle of the cleaning agent 13 bounces off the surface of the object 11 while carrying the entrapped foreign material 12 away from the object 11 as shown in FIG. 4C. Since the foreign material 12 is captured by the particle of the cleaning agent 13 and removed away from the object 11 in this fashion, the foreign material 12 does not remain in a free state within the cleaning apparatus. In this case, the foreign material 12 removed from the surface of the object 11 does not hinder successful cleaning operation by becoming redeposited to the object 11 or by sticking to the inner wall surface of the cleaning apparatus after removal from the object 11.

While the foregoing discussion has illustrated the invention referring to an example in which the surface of the object 11 is cleaned by blasting the particles of the cleaning agent 10, the invention is not limited to the illustrated example. Even when the cleaning agent 10 is used in a barrel cleaner in which an object is cleaned by collision (or contact) between the object and particles of a cleaning agent caused by stirring the object and the cleaning agent particles together in the barrel cleaner, the cleaning agent 10 of the invention offers the same advantageous effect as thus far described in removing foreign materials from the surface of the object. This is because the particles of the cleaning agent 10 collide with the object to be cleaned even when used in the barrel cleaner. It is needless to say that the cleaning agent 10 of the invention produces the same advantageous effect in removing foreign materials from the surface of the object even when used in other types of cleaning apparatus as long as collision between the object to be cleaned and the particles of the cleaning agent 10 is produced in the cleaning apparatus.

After the foreign material 12 has been removed from the object 11 to be cleaned as described above (FIG. 4C), the object 11 undergoes a final cleaning stage. In the final cleaning stage, other types of dirt and unwanted impurities, such as oil and water, which can not be removed by applying the cleaning agent 10 alone are removed by a wet-cleaning method. (washing and drying) by use of an chlorofluorocarbon-replacing material to complete the cleaning process.

Since the foreign material 12 adhering to the surface of the object 11 is removed by the cleaning agent 10 which entraps the foreign material 12 as mentioned above, it is possible to remove the foreign material 12 even if the same firmly holds on the surface of the object 11 with a magnetic force. Also, even when the foreign material 12 firmly sticks to the surface of the object 11 with an electrostatic force, the foreign material 12 can be removed from the surface in a reliable fashion.

The particulate body 1 of the cleaning agent 10 of the embodiment is made of gelatin or animal glue as previously mentioned. Therefore, even when the particle of the cleaning agent 10 collapses as a result of collision with the object 11 to be cleaned or for other reasons, fragmented parts of the particle recombine and assume its original shape due to inherent properties of the constituent material (gelatin or animal glue) of the particulate body 1. This feature of the cleaning agent 10 serves to prevent loss of quantity of the cleaning agent 10 and deterioration of its cleaning efficiency as a result of using in the cleaning operation.

The cleaning apparatus has an internal cleaning agent collecting space where the particles of the cleaning agent 10 are collected and stored for cyclical use. In a case where the foreign materials are magnetic metals, there should preferably be disposed a permanent magnet in the cleaning agent collecting space of the cleaning apparatus. When the particles of the cleaning agent 10 are carried back to the cleaning agent collecting space after cleaning, there exists the permanent magnet close to the particles which contain the magnetic foreign materials. Consequently, the magnetic foreign materials are attracted by the permanent magnet and removed from the particles of the cleaning agent 10. The particles of the cleaning agent 10 from which the foreign materials have been removed are recirculated in the cleaning apparatus and blasted thereby to execute continued cleaning operation. More preferably, there is disposed an agitating device in the cleaning agent collecting space of the cleaning apparatus for stirring up the particles of the cleaning agent 10. This arrangement ensures that the individual particles of the cleaning agent 10 are certainly brought to the proximity the permanent magnet so that the foreign materials are taken off the cleaning agent 10 in a more reliable fashion.

Featuring long-lasting cleaning performance and a capability to offer improved efficiency of cleaning operation, the cleaning agent 10 of the first embodiment can efficiently clean surfaces of an object to be cleaned. A conventional coating process (e.g., plating) often produces foreign materials known as “droplets” left on a workpiece after the coating process. The coating process usually imparts strong magnetism to the workpiece and, thesefore, the droplets are firmly attracted to surfaces of the workpiece by this magnetism.

Some conventional cleaning apparatuses further employ a demagnetizing process for eliminating this kind of magnetism. The demagnetizing process can not completely remove the magnetism, however. In addition, the demagnetizing process can not prevent adhesion of other types of foreign material than the coating droplets at all. Normally, a coated object is not subjected to a cleaning process because the cleaning process performed by the conventional cleaning method could damage a coating of the object.

According to the aforementioned cleaning method of the invention, foreign materials adhering to an object to be cleaned are removed with the aid of the viscosity of the particulate bodies 1 of the cleaning agent 10 having the elastic property. It is therefore possible to remove the foreign materials including the droplets firmly adhering to the coated workpiece with magnetism by using the cleaning agent 10 of the embodiment without damaging the surfaces thereof. It will be appreciated from the foregoing discussion that the cleaning method of the invention makes it possible to prevent peeling of the coating due to the presence of droplets or other foreign materials adhering to coated surfaces even when the method is applied to such objects as metal dies and drilling tool components after the coating process.

While the foregoing discussion of the first embodiment has illustrated an example in which the particles of the cleaning agent 10 are blasted obliquely downward from the impeller 5, the invention is not limited to this form of application but the particles of the cleaning agent 10 may be blown obliquely upward, for example. The stream of the particles of the cleaning agent 10 can be blasted at desired angles against the surfaces of the object to be cleaned by properly controlling rotary motion of the impeller 5, without moving the object.

While only water is contained in the particulate bodies 1 of the cleaning agent 10 in the first embodiment thus far described, other material such as an appropriate antiseptic may be added, for instance. While the cleaning agent 10 of the embodiment has been described as being useful for cleaning various objects with reference to some specific examples of constituent materials, the cleaning agent 10 is also applicable to other kinds of materials as long as foreign matter adhering thereto can be successfully removed.

Additionally, although the blasting device including the impeller 5 has been discussed with reference to the example depicted in FIG. 2 as a device for producing a stream of the particles of the cleaning agent 10, the invention is not limited thereto. Widely used commercially available air-blasting machines, for example, can be similarly used for producing a particle stream of the cleaning agent 10 without jeopardizing the aforementioned advantageous effect of the invention.

### Second Embodiment

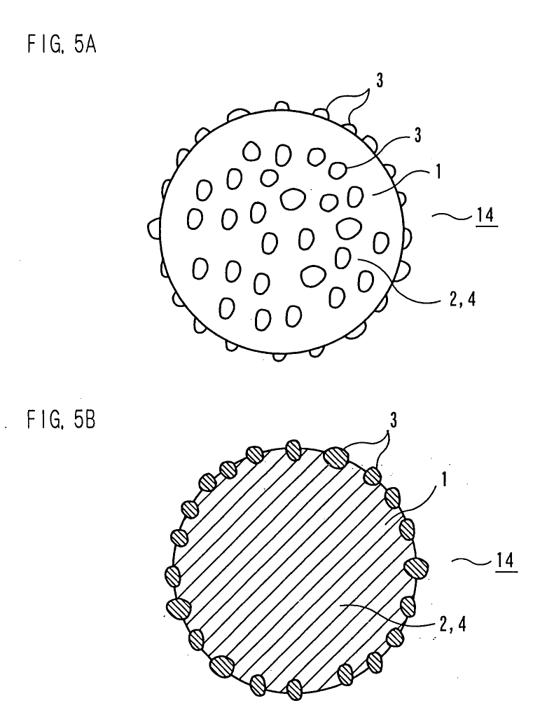

FIG. 5A is a diagram showing the structure of a single particle of a cleaning agent 14 according to a second embodiment of the invention, and FIG. 5B is a sectional view of the particle of the cleaning agent 14 of FIG. 5A, in which elements identical or similar to those of the first embodiment are designated by the same reference numerals. In the second embodiment, a particulate body 1 of each particle of the cleaning agent 14, covered by a plurality of stick-free fragments 3 like the particulate body 1 of the first embodiment, contains an anti-evaporation substance 4 in addition to water 2.

The anti-evaporation substance 4 used in this embodiment is water-soluble oil, such as ethylene glycol or sorbitol, for instance. The water-soluble oil used as the anti-evaporation substance 4 serves to retain the water 2 within the particulate body 1 and prevent wetting of the surface of an object to be cleaned with water.

The amount of the anti-evaporation substance 4 added should approximately be equal to the amount of water when sorbitol is used. When other material is used as the anti-evaporation substance 4, it is necessary to determine the mixing ratio of the anti-evaporation substance 4 to be added depending on the molecular weight and other properties of the material since its proper mixing ratio varies with such properties.

A cleaning method performed by using the cleaning agent 14 of the second embodiment is generally the same as the cleaning method previously explained in the aforementioned first embodiment. Generally speaking, when an object to be cleaned is cleaned by using a cleaning agent shaped to a desired particle size, both the cleaning agent and the object to be cleaned are heated due to frictional heat produced by collisions between individual particles of the cleaning agent and the object. When the cleaning agent is thus heated, water contained in individual particulate bodies of the cleaning agent would evaporate.

Since such heating phenomenon occurs in the cleaning method of the invention as well, the water 2 will evaporate as a result of heating if the object is cleaned by blasting the cleaning agent 10 of the first embodiment of which particulate bodies 1 contain the water 2 alone and not the anti-evaporation substance 4. If the water 2 evaporates in this manner, the particulate bodies 1 of the cleaning agent 10 loose their elasticity and viscosity. As a result, the capability the cleaning agent 10 to capture foreign materials deteriorates, making it impossible to achieve a desired result of cleaning. This means that conditions under which the cleaning agent 10 of the first embodiment can be used are more or less limited by the heating phenomenon.

By comparison, the cleaning agent 14 of the second embodiment contains not only the water 2 but also the anti-evaporation substance 4 which prevents evaporation of the water 2 and, therefore, water evaporation due to heating of the cleaning agent 14 is considerably suppressed. Even when the cleaning agent 14 is continuously used in a prolonged cleaning operation, the cleaning agent 14 remains in a state in which the individual particulate bodies 1 of the cleaning agent 10 retain a specific level of water content and desired levels of elasticity and viscosity. Thus, the cleaning agent 14 of the second embodiment is more suited for continued use in the cleaning operation.

Furthermore, if water-soluble oil is used as the anti-evaporation substance 4 as stated above, the anti-evaporation substance 4 retains the water 2 within the particulate bodies 1. This makes it possible to prevent wetting of the surface of the object to be cleaned with water and consequent oxidization (corrosion) of the object.

The foregoing discussion about inclusion of water in the particulate bodies of the cleaning agent applies also to storage and inventory management of the cleaning agent. If the cleaning agent contains water alone, and not any anti-evaporation substance, in the particulate bodies as in the cleaning agent 10 of the first embodiment, the water in the particulate bodies will evaporate while the cleaning agent is stored under unused conditions. The cleaning agent which has lost its water content performs just like the earlier-mentioned conventional cleaning agents and will no longer exhibit satisfactory cleaning performance intended in the present invention. If the cleaning agent contains an anti-evaporation substance in addition to water in the particulate bodies as in the cleaning agent 14 of the second embodiment, the water would hardly evaporate under ordinary storage conditions.

The inventor conducted experiments to compare the cleaning performance of the cleaning agent 10 of the first embodiment and the cleaning agent 14 of the second embodiment. Results of this comparative testing indicate that, although both types of cleaning agents 10, 14 of the invention exhibit far higher cleaning performance as compared to the conventional cleaning agents, the cleaning agent 14 containing the water 2 and the anti-evaporation substance 4 in the particulate bodies 1 offers several times longer useful life than the cleaning agent 10 containing the water 2 alone without loosing the desired cleaning performance.

1. A cleaning agent for cleaning a surface of an object to be cleaned by collisions between the cleaning agent and the object, the cleaning agent comprising:
a plurality of particulate bodies made essentially of a material selected from the group consisting of gelatin and animal glue, and containing water to impart viscosity and elasticity thereto; and
a plurality of stick-free fragments held on an outer surface of each of the particulate bodies, the stick-free fragments preventing individual particulate bodies from sticking to one another and maintaining the particulate bodies in an original shape, wherein the cleaning agent is used under conditions where the particulate bodies maintain their viscosity and elasticity by retaining the water so that the cleaning agent can capture foreign material on the surface of the object.

2. The cleaning agent according to claim 1, wherein the individual particulate bodies have a particle size of 0.1 mm to 3 mm in diameter.

3. The cleaning agent according to claim 2, wherein the stick-free fragments are a ceramic material.

4. The cleaning agent according to claim 3, wherein the individual stick-free fragments have a diameter of 1 μm to 20 μm.

5. The cleaning agent according to claim 3, wherein the ceramic material includes at least one substance selected from the group consisting of diamond, silicon carbide, alumina, glass, and zirconia.

6. The cleaning agent according to claim 1, wherein the weight ratio of the particulate bodies to the water falls within a range of 10:2 to 10:7.

7. The cleaning agent according to claim 1 further comprising an anti-evaporation substance for preventing evaporation of the water, the anti-evaporation substance being contained in the particulate bodies.

8. The cleaning agent according to claim 7, wherein the anti-evaporation substance is a water-soluble oil.

9. A cleaning method for cleaning a surface of an object to be cleaned by using a cleaning agent which comprises a plurality of particulate bodies made essentially of a material selected from the group consisting of gelatin and animal glue, the particulate bodies containing water to impart viscosity and elasticity, and a plurality of stick-free fragments held on an outer surface of each of the particulate bodies, the stick-free fragments preventing the individual particulate bodies from sticking to one another and maintaining the particulate bodies in an original shape, said cleaning method comprising:
colliding the cleaning agent with the object under conditions in which the particulate bodies retain the water;
capturing foreign material on the surface of the object with the particulate bodies; and
removing the foreign material from the surface of the object.

10. The cleaning method according to claim 9 further comprising:
after removing the foreign material, washing the surface of the object in a wet-cleaning process using a chlorofluorocarbon-replacing material; and
drying the surface of the object.

11. The cleaning method according to claim 10, wherein the foreign material on the surface of the object is a magnetic material, and including bringing the cleaning agent used for cleaning the object close to a magnet to remove the foreign material from the cleaning agent for reuse in another cleaning operation.
